(19) United States
(12) Patent Application Publication
(10) Pub. No.: US 2005/0025264 A1
(43) Pub. Date: Feb. 3, 2005

(54) Device and method of estimating frequency offset in radio receiver

(76) Inventor: Hung-Kun Chen, Hsinchu City (TW)

Correspondence Address: Samuels, Gauthier & Stevens LLP, Suite 3300, 225 Franklin Street, Boston, MA, 02110, US

(21) Appl. No.: 10/628,810

(22) Filed: Jul. 28, 2003

(51) Int. Cl. H04L 1/00

(52) U.S. Cl. 375/346

(57) ABSTRACT

Disclosure is a device and a method for estimating frequency offset in radio receiver. Said device comprises: an analog-to-digital converter, a first storing means having M elements; a multiplication means for performing multiplication between a complex conjugate of delayed sampled element and a current sampled element; a second storing means having N elements; an accumulating means for accumulating output of said multiplication means; and a subtracting means for sequentially subtracting output of second storing means from output of said accumulating means; an estimating means for generating said estimated frequency offset based on an output of said subtracting means. Furthermore, said method is achieved by utilizing the above device in the same principle.

### BACKGROUND OF THE INVENTION

1. Technical Field

The present invention relates to a device and a method of estimating frequency offset in a radio receiver, and more particularly to a device and a method of estimating frequency offset in radio receiver receiving preamble signals that comprises of a sequence of short symbols following by a sequence of long symbols.

2. Description of the Prior Art

The development of wireless communication is rapidly growing as its convenience in mobility. There are several protocols for wireless communication. Wireless 802.11a is one of protocols that provide a relative inexpensive and high speed transmission for the field of wireless communication as compared with other protocols. 802.11a is a standard for communicating between multiple devices using wireless in a maximum data rate of 54 megabits per second (Mbps) to which the effective throughput is more than 20 Mbps. The data rate of 802.11a is alternated between Mbps of 54, 38, 36, 24, 18, 12, 9 and 6, under the band of 5.15-5.25, 5.25-5.35 and 5.725-5.825 GHz. A modulation technology called as orthogonal frequency division multiplexing (OFDM) is employed in 802.11a.

Typically, same as the conventional wireless communication, the communication in 802.11a also meets the impairment in transmitted signals. These impairments include signal fading, multi-path reflections, base- and remote-unit oscillator mismatch introduced frequency offset, timing misalignment, and timing synchronization. Frequency offset estimation is widely employed to compensate the frequency offset in received signal.

The structure of preamble conforming to IEEE 802.11a specification could be found in FIG. 1. In conventional solutions to frequency estimation offset, they usually provide a coarse frequency estimation scheme that estimates the frequency offset of short symbols in preamble signals, and following a fine frequency estimation scheme that estimates the frequency offset of long symbols in preamble signals. The estimated coarse frequency offset value is for compensating the signal received in fine frequency estimation scheme so as to obtain estimated offset value of fine frequency estimation scheme. The total estimated value is found by adding the offset value in coarse frequency estimation with the offset value in fine frequency estimation.

The applicant of the present application found that the accuracy of coarse frequency offset estimation plays a very important role for estimating the total frequency offset, because, as mentioned in previous paragraph, the coarse frequency offset estimation works for compensating the fine frequency offset estimation. The applicant also found a phenomenon that the beginning portion of received signal always imposed with an unstabler frequency offset as compared with the following portion of received signal, as shown in FIG. 2. If such unstabler signal in the beginning portion of received signal could be discarded in the receiving side, the result of the coarse frequency offset estimation could be greatly improved. However, it is difficult for the receiving side to determine when the beginning portion starts. Many prior arts of coarse frequency offset estimation are known in the field. However, these prior arts of coarse frequency offset estimation could not avoid utilizing the beginning portion of signal for estimation

With respect to these coarse frequency estimation schemes, a prior art could be found in FIG. 3. In the scheme of the prior art, sampled elements are stored in a FIFO buffer 301 as well as at the same time fed to a multiplier 302 for performing the multiplication between a conjugated result of an output of the FIFO buffer 301 and a current sample. An accumulator 304 accumulates the value of the multiplier 302. When a control signal 303 is active, the value in the accumulator 304 is then used to perform an angle process 305 that derives a corresponding angle according to the value in the accumulator 304. Then the value derived in the angle process 305 is then divided by sampled numbers in one cycle period of a short symbol (process 306) to obtain a value of T_{S}\hat{ω}_{d,short}. However, the scheme in this prior art could not avoid utilizing the beginning portion of signal, and thus it could not provide a good estimation for coarse frequency offset estimation. Accordingly, the compensation that utilizes the improper coarse frequency offset estimation will downgrade the performance of the fine frequency offset estimator and other unit, for example, the channel estimator.

In other words, an improved frequency offset estimation scheme is desired so as to avoid utilizing the beginning portion of received signal while processing the frequency offset estimation for OFDM signal.

### SUMMARY OF THE INVENTION

The object of the present invention is to provide a device and a method for estimating frequency offset value in coarse frequency estimation for OFDM system in a radio receiver so as to overcome the drawbacks as described above. The present invention relates to a device of estimating frequency offset in a receiver receiving an analog signal, said device comprising: an analog-to-digital converter for converting said received analog signal to a sequence of sampled elements; a first storing means having M elements that sequentially stores said sampled elements, for delaying each said sampled elements by M samples to generate a delayed sampled element; a multiplication means for performing multiplication between a complex conjugate of said delayed sampled element and a current sampled element; a second storing means having N elements that sequentially stores an output of said multiplication means, for delaying each said output of said multiplication means; an accumulating means for accumulating said output of said multiplication means; and a subtracting means for sequentially subtracting output of said second storing means from output of said accumulating means; an estimating means for generating said estimated frequency offset based on an output of said subtracting means. Furthermore, the present invention relates to a method of estimating frequency offset, comprising the steps of: receiving a sequence of signal samples which are complex numbers; delaying said signal samples by a first delay value; performing multiplication between each said signal sample and a complex conjugate of each said delayed signal sample to generate a first value; delaying each said first value by a second delay value; accumulating said first value to generate a second value; subtracting each said delayed first value from said second value to generate a third value; and generating said estimated frequency offset based on said third value.

### BRIEF DESCRIPTION OF THE DRAWINGS

FIG. 1 is a diagram representing the sampling of the short preamble used in training sequences of IEEE-802.11a protocol;

FIG. 2 shows the phenomenon in the beginning portion of received signal in communication system;

FIG. 3 is a conceptual diagram illustrating a method of coarse frequency offset estimation in a prior art;

FIG. 4 is a block diagram showing the steps of coarse frequency offset estimation of the present invention;

FIG. 5 is a diagram showing how the frequency offset of signal is nullified in the embodiment of the present invention;

FIG. 6 is a block diagram showing the steps of fine frequency offset estimation of the present invention; and

FIG. 7 is a conceptual diagram showing the combination of the frequency offset value estimated in coarse frequency offset estimation and the frequency offset value estimated in fine frequency offset estimation.

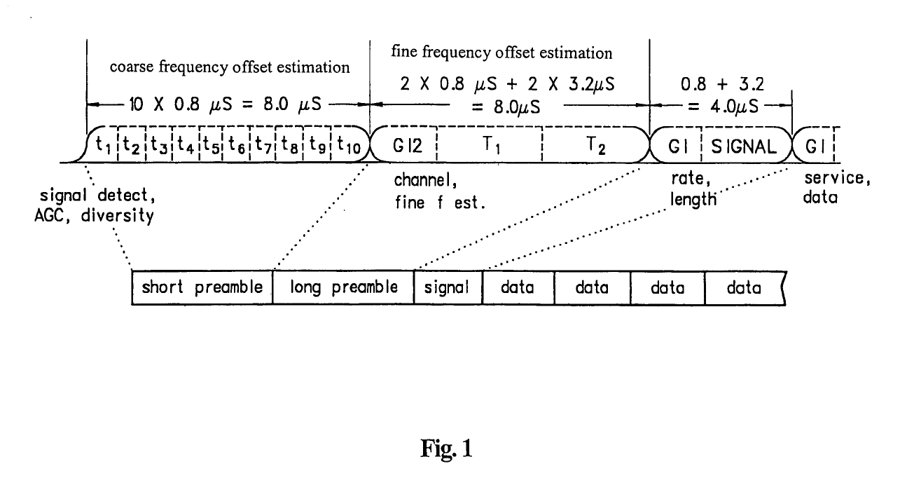

### DETAILED DESCRIPTION OF THE INVENTION

Prior to the explanation of the embodiment of the present invention, the disclosure would firstly lineout the principle of operation of the present invention. First, we consider a signal that is periodic within the range of t₁ t t₂. It can be expressed as x(t)=x(t−T), ∀tε[t₁+T,t₂], where T is the period.

At the receiver side, the received signal can be expressed by
r(t)=e^{jωdt}y(t)+z(t)
y(t)=x(t)\mathring{x}h(t)
where
ω_{d} is the angular frequency offset,
h(t) is the channel impulse response,
z(t) is the additive noise term,
\mathring{x} is the operator of convolution.

It can be shown that y(t) is also periodic with the same period in a somewhat small range. In order to prove this, we further assume that the impulse response is causal and has a finite duration Tₕ.

$$∀ t ∈ [ {t}_{1} + T + {T}_{h} , {t}_{2} ] y ( t ) = {\int }_{0}^{{T}_{h}} ( τ ) x ( t - τ ) ⅆ τ \qquad ( 1 )$$

In the integration range 0 τ Tₕ, we have
t₁+T t−τ t₂, and x(t−τ)=x(t−τ−T) (2)
Thus

$$\begin{matrix}y ( t ) = {\int }_{0}^{{T}_{h}} h ( τ ) x ( t - τ ) ⅆ τ \\ = {\int }_{0}^{{T}_{h}} h ( τ ) x ( t - τ + T ) ⅆ τ = y ( t - T )\end{matrix} \qquad ( 3 )$$

Using this periodic property, the frequency offset can be estimated through a differential operation. Let
μ(t)=r(t)r*(t−T)=[e^{jωdt}y(t)+w(t)][e^{jωd(t-T)}y(t−T)+z(t−T)]* (4)
Neglect the noise terms,
μ(t)=[e^{jωdt}y(t)][e^{jωd(t-T)}y(t−T)]*=e^{jωdT}y(t)y*(t−T) (5)
In the region where y(t)=y(t−T) applies,
μ(t)=e^{jωdT}|y(t)|² (6)
Obviously, the frequency offset can be obtained by the phase of μ(t). More reliable estimator can be obtained by the integral of μ(t). Let

$$U = {\int }_{t ∈ I}^{} μ ( t ) ⅆ t \qquad ( 7 )$$

where I is some region that the equality y(t)=y(t−T) holds.

$$U = {\int }_{t ∈ I}^{} {ⅇ}^{jω dT} {\vert y ( t ) \vert}^{2} ⅆ t = {ⅇ}^{jω dT} {\int }_{t ∈ I}^{} {\vert y ( t ) \vert}^{2} ⅆ t \qquad ( 8 )$$

And the frequency offset estimator is

$${\hat{ω}}_{d} = \frac{1}{T} 〈 U = \frac{1}{T} 〈 {\int }_{t ∈ I}^{} r ( t ) {r}^{*} ( t - T ) ⅆ t \qquad ( 9 )$$

For digital processing, the received signal is sampled.
r[n]=r(t=nT_{S}) (10)
where n is the discrete time index and T_{D} is the sampling period. The estimator becomes

$${\hat{ω}}_{d} = \frac{1}{T} 〈 U = \frac{1}{T} 〈 {\sum }_{k ∈ I} r [ n ] {r}^{*} [ n - L ] \qquad ( 11 )$$

Normally we are interested in the phrase rotation per sample,

$${T}_{s} {\hat{ω}}_{d} = \frac{{T}_{s}}{T} 〈 {\sum }_{k ∈ I} r [ n ] {r}^{*} [ n - L ] = \frac{1}{L} 〈 {\sum }_{k ∈ I} r [ n ] {r}^{*} [ n - L ] \qquad ( 12 )$$

where L=T/T_{S} is an integer and is the period of signal in terms of digital sample. Note that both the 802.11a short symbol sequence and long symbol sequence have the periodic property. Thus we can apply this scheme.

In the estimator, there is an operation of taking the angle. Due to the 2π periodic nature of angle, the operation has limited unambiguous
|∠U|<π
Thus the frequency offset estimator also has limited range,

$$\vert {\hat{f}}_{d} = \frac{1}{2 π} {\hat{ω}}_{d} = \frac{1}{2 π \cdot T} 〈 U \vert < \frac{1}{2 T}$$

The above is the principle of operation of the present invention.

Accordingly, we conclude that a smaller value of signal period gives larger frequency estimation range. In 802.11a with a preamble design, the preamble includes a short symbol sequence, following by a long symbol sequence. Therefore, there are a coarse frequency offset estimation having larger estimation range in the short symbol sequence and a fine frequency offset estimation having smaller estimation range in the long symbol sequence.

The method of frequency offset estimation of the present invention includes a coarse frequency offset estimation in the short symbol sequence and a fine frequency offset estimation in the long symbol sequence.

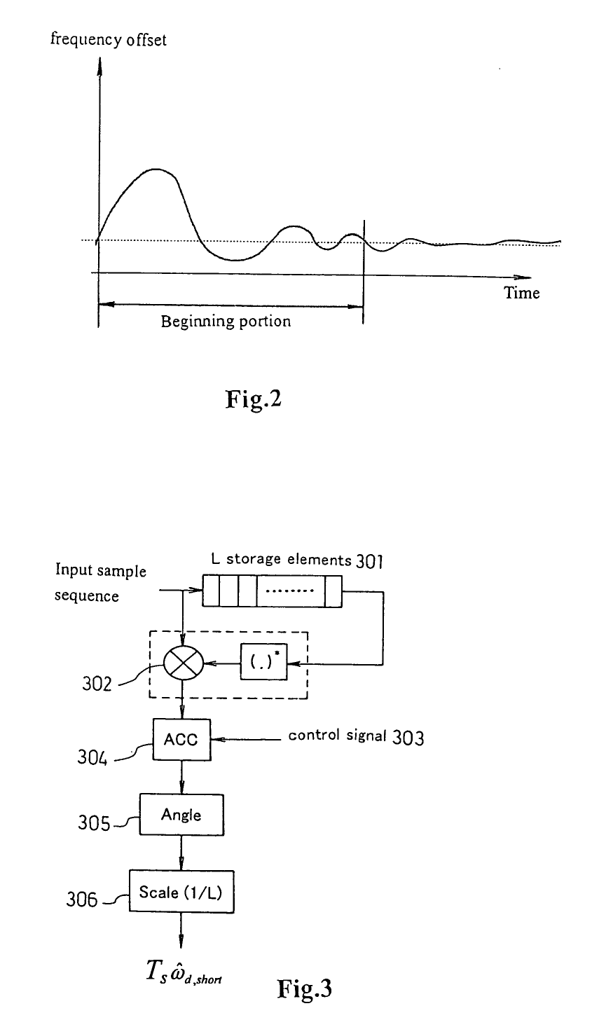

However, for a reason that the beginning portion of received signal always imposed with a unstabler frequency offset as compared with the following portion of received signal, as shown in FIG. 2, the present invention is to provide a scheme to nullify the beginning unstable portion of received signal for coarse frequency offset estimation.

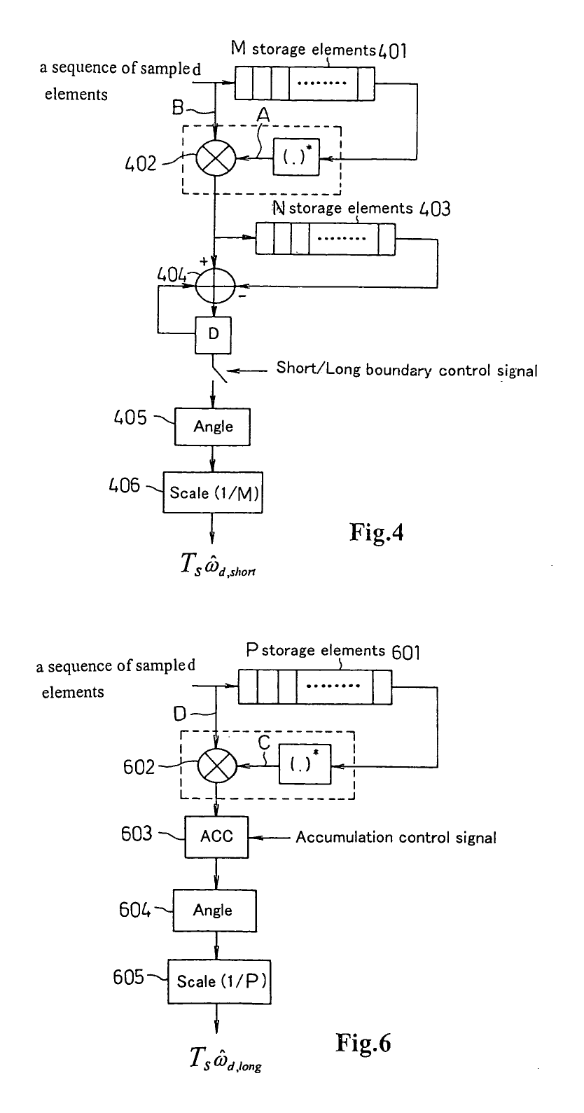

FIG. 4 is a block diagram showing the steps and device of coarse frequency offset estimation of the present invention. An input signal received by an analog-to-digital converter (not shown) is sampled as a sequence of sampled elements. A first FIFO buffer 401 with a length of M=16 samples, but not limited, is provided. The sampled elements are then stored in the first FIFO buffer 401 as well as at the same time fed to a multiplier 402 for performing the multiplication between a conjugated result (*data in point A) of an output of the first FIFO buffer 401 and a current sample (*data in point B). In other words, the output of the first FIFO buffer is conjugated, and then fed into the multiplier 402. The multiplication is performed based on the conjugated result (*data in point A) and a current sample (*data in point B). The result of the multiplication is then both sent to a second FIFO buffer 403 and an accumulator 404. The second FIFO buffer 403 with a length of N=32 samples, but not limited, is provided. Note that the length of the second FIFO buffer 403 is preferably larger than that of the first FIFO buffer 401 to achieve better estimation accuracy. The accumulator 404 accumulates the result of said multiplication. While an output from the second FIFO buffer 403 is arrived, the accumulator 404 would subtract the output of the second FIFO buffer 403 from the value accumulated in the accumulator 404. The subtraction here is very important because the beginning portion of received signal always imposed with an unstabler frequency offset as compared with the following portion of received signal. With the subtraction of the present invention, the beginning portion of the received signal will be nullified and will not affect the frequency offset estimation. Therefore the accuracy of the estimation can be improved accordingly.

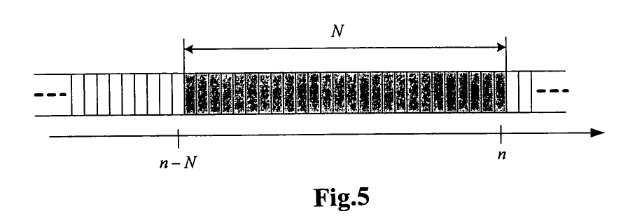

As a result, please referring to FIG. 5, the instantaneous frequency offset estimated at time instance n−N will be neglected by the accumulated frequency offset estimated at time instance n. Thus the resultant frequency offset estimation is obtained based on the N most recently instantaneous frequency offset estimations prior to the time instance n₀ at which the Short/Long boundary control signal is active. Accordingly, the unstabler frequency offset in the beginning portion of signal samples, which typically happens prior to the time period [n₀−N, n₀], would be disregarded by the present invention, so that the estimated frequency offset would be more accurate. When the Short/Long boundary control signal is active, the value in the accumulator 404 would be used to perform an angle process that derives a corresponding angle according to the value in the accumulator 404. Then the value derived in the angle process 405 is divided by sampled numbers in one cycle period of a short symbol (process 406) to obtain a value of T_{S}\hat{ω}_{d,short}. The above process is the implementation of formula (12).

The value of T_{S}\hat{ω}_{d,short} obtained in coarse frequency offset estimation above would be utilized to compensate the following fine frequency offset estimation.

FIG. 6 is a block diagram showing the steps and device of fine frequency offset estimation of the present invention. An input signal also received by an analog-to-digital converter (not shown) is sampled as a sequence of sampled elements. A FIFO buffer 601 with a length of P=64 samples, but not limited, is provided. The sampled elements are then stored in the FIFO buffer 601 as well as at the same time fed to a multiplier 602 for performing the multiplication between a conjugated result (*data in point C) of an output of the FIFO buffer 601 and a sample presently sampled (*data in point D). In other words, the output of the FIFO buffer 601 is conjugated (*data in point C), and then fed into the multiplier 602. The multiplication is performed based on the conjugated result (*data in point C) and a sample that is presently being sampled (*data in point D). The result of the multiplication is then sent to an accumulator 603. The accumulator 603 continues accumulating the result of said multiplication. Then, at a control portion, there provides a control signal called as an “Accumulation control signal” for specifying when to derive value in the accumulator 603. When the control signal is active, the value in the accumulator 603 would be derived for performing angel process that derives a corresponding angle according to the value in the accumulator 603, and then the value derived in the angle process 604 is divided by sampled numbers in one cycle period of a short symbol (process 605) to obtain a value of T_{S}\hat{ω}_{d,long}. The above process is also the implementation of the above formula (12).

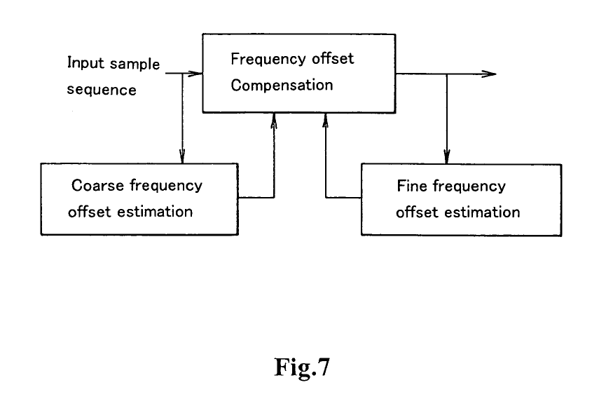

The value of T_{S}\hat{ω}_{d,long} obtained in fine frequency offset estimation above would be utilized to add with T_{S}ω\hat{ω}_{d,short} so as to derive T_{S}\hat{ω}_{d}. Therefore, use T_{S}\hat{ω}_{d} as the frequency offset estimation for compensating the further received signal, as shown in FIG. 7.

While this invention has been described in connection with what is presently considered to be the most practical and preferred embodiments, it is to be understood that the invention is not limited to the disclosed embodiment, but, on the contrary, it is intended to convert various modifications and equivalent arrangements included within the spirit and scope of the appended claims.

1. A method of estimating frequency offset, comprising the steps of:
receiving a sequence of signal samples which are complex numbers;
delaying said signal samples by a first delay value;
performing multiplication between each said signal sample and a complex conjugate of each said delayed signal sample to generate a first value;
delaying each said first value by a second delay value;
accumulating said first value to generate a second value;
subtracting each said delayed first value from said second value to generate a third value; and
generating said estimated frequency offset based on said third value.

2. A method of claim 1, wherein said second delay value is larger than said first delay value.

3. A method of estimating frequency offset in a receiver, comprising the steps of:
receiving a first portion of signal samples which are complex numbers;
receiving a first control signal;
deriving a first frequency offset estimation based on said first portion of signal samples;
receiving a second portion of signal samples which follows said first portion of signal samples;
compensating said second portion of signal samples by utilizing said first frequency offset estimation so as to generate a compensated second portion of signal samples;
deriving a second frequency offset estimation based on said compensated second portion of signal samples; and
obtaining a total frequency offset estimation based on said first frequency offset estimation and said second frequency offset estimation.

4. A method of claim 3, wherein the first frequency offset estimation keeps constant after said first control signal is active.

5. A method of claim 3, wherein the step of deriving said first frequency offset estimation comprises the steps of:
delaying said first portion of signal samples by a first delay value;
performing multiplication between each said signal sample and a complex conjugate of each said delayed signal sample to generate a first value;
delaying each said first value by a second delay value;
accumulating said first value to generate a second value;
subtracting each said delayed first value from said second value to generate a third value; and
generating said estimated frequency offset based on said third value.

6. A method of claim 5, wherein said second delay value is larger than said first delay value.

7. A method of claim 3, wherein the step of deriving a second frequency offset estimation comprising the steps of:
delaying each of said partial compensated second portion of signal samples by a third delay value;
performing multiplication between each said partial compensated signal sample and a complex conjugate of each said delayed partial compensated signal sample to generate a fourth value;
accumulating said fourth value to generate a fifth value;
generating said second frequency offset estimation based on said fifth value.

8. A device of estimating frequency offset in a receiver receiving an analog signal, said device comprising:
an analog-to-digital converter for converting said received analog signal to a sequence of sampled elements;
a first storing means having M elements that sequentially stores said sampled elements, for delaying each said sampled elements by M samples to generate a delayed sampled element;
a multiplication means for performing multiplication between a complex conjugate of said delayed sampled element and a current sampled element;
a second storing means having N elements that sequentially stores an output of said multiplication means, for delaying each said output of said multiplication means by N samples;
an accumulating means for accumulating said output of said multiplication means; and
a subtracting means for sequentially subtracting output of said second storing means from output of said accumulating means;
an estimating means for generating said estimated frequency offset based on an output of said subtracting means.

9. A device of claim 8, wherein the value of N is larger than the value of M.

10. A device of estimating frequency offset in a receiver receiving an analog signal and converting said analog signal to a series of signal samples which are complex number, said device comprising:
first deriving means for deriving a first frequency offset estimation based on a first portion of said signal samples;
compensating means for compensating a frequency offset of a second portion of said signal samples which follows said first portion of signal samples by utilizing said first frequency offset estimation so as to generate a compensated second portion of signal samples;
second deriving means for deriving a second frequency offset estimation based on said compensated second portion of signal samples;
estimating means for computing a total frequency offset estimation based on said first frequency offset estimation and said second frequency offset estimation.

11. A device of claim 10, wherein the device further receives a first control signal, and said first frequency offset estimation keeps constant after said first control signal is active.

12. A device of claim 10, wherein the device further receives a second control signal, and said second frequency offset estimation keeps constant after said second control signal is active.

13. A device of claim 10, wherein said first deriving means for deriving a first frequency offset estimation comprising:
a first delaying unit having M elements for delaying each of said first portion of signal samples by M samples to generate a delayed signal sample;
a multiplication unit for performing multiplication between each said signal sample and a complex conjugate of each said delayed signal sample to generate a first value;
a second delaying unit having N elements for delaying each said first value by N samples to generate a delayed first value;
an accumulating unit for accumulating said first value to generate a second value;
a subtracting unit for sequentially subtracting each said delayed first value from said second value to generate a third value; and
an estimating unit for computing said first frequency offset estimation based on said third value.

14. A device of claim 13, wherein the value of N is larger than the value of M.

15. A method of claim 10, wherein said deriving means for deriving a second frequency offset estimation comprising:
a delaying unit for delaying each of said partial compensated second portion of signal samples;
a multiplication unit for performing multiplication between each said partial compensated signal sample and a complex conjugate of each said delayed partial compensated signal sample to generate a fourth value;
an accumulating unit for accumulating said fourth value to generate a fifth value; and
an estimating unit for computing said second frequency offset estimation based on said fifth value.
